(19) United States
(12) Patent Application Publication
(10) Pub. No.: US 2012/0223681 A1
(43) Pub. Date: Sep. 6, 2012

(54) Electrodes, Batteries, Electrode Production Methods, and Battery Production Methods

(76) Inventors: Bradley W. Stone, Elmwood, IL (US); Alfred T. Volberding, Kirkland, WA (US)

(21) Appl. No.: 13/408,764

(22) Filed: Feb. 29, 2012

Related U.S. Application Data
(60) Provisional application No. 61/449,259, filed on Mar. 4, 2011.
(60) Provisional application No. 61/531,460, filed on Sep. 6, 2011.

(51) Int. Cl. H01M 10/04; H01M 4/64; H01M 10/18; B05D 5/12; H01M 4/46; H01M 4/40; H01M 4/38; H02J 7/00; H01M 4/36; H01M 2/00

(52) U.S. Cl. 320/137; 429/209; 429/225; 429/211; 429/210; 429/162; 429/156; 429/212; 429/218.1; 429/223; 429/219; 429/220; 427/58

(57) ABSTRACT

Electrodes as well as electrode production methods are provided that can include a substrate with the substrate comprising non-conductive material. Batteries including electrodes of the disclosure are provided. Electricity storage methods are provided that can utilize the electrodes and/or batteries of the disclosure.

### CROSS-REFERENCE TO RELATED APPLICATIONS

This application claims priority to U.S. Provisional Patent Application Ser. No. 61/449,259 which was filed on Mar. 4, 2011, entitled “Rechargeable Batteries, Lead-Acid Batteries, Battery Components, and Battery Methods”, and U.S. Provisional Patent Application Ser. No. 61/531,460 which was filed on Sep. 6, 2011, entitled “Rechargeable Batteries, Lead-Acid Batteries, Battery Components, and Battery Methods”, the entirety of each of which is incorporated by reference herein.

### TECHNICAL FIELD

The present disclosure relates to electrodes, batteries, electrode production methods, and battery production methods. In more particular embodiments the disclosure relates to Rechargeable Batteries, Lead-Acid Batteries, Battery Components, and Battery Methods. Particular embodiments of the disclosure relate to novel electrode constructions and/or methods of manufacturing electrodes.

### BACKGROUND

Rechargeable batteries such as lead-acid batteries can include one or more cathodic electrodes that may be constructed by casting lead, expanding lead sheet, or creating a lead alloy foil with punched grid pattern. Typically the cathodic electrode is comprised of 100% lead or lead alloy. Rechargeable batteries such as lead-acid batteries also can include one or more anodic electrodes that utilize a lead oxide, or derivative, pasted onto a traditional lead battery electrode substrate.

### SUMMARY

The electrodes of the present disclosure can be configured to be utilized in standard lead acid battery manufacturing processes and equipment.

Batteries of the present disclosure can have enhanced electrode performance by increasing active-material-surface area and improving electrode conductivity, thus creating a more uniform current distribution across the electrode resulting in a decreased operating temperature. These attributes may allow for enhanced electrode performance and increased cycle life at a wider range of operating temperatures.

The present disclosure provides low cost, light weight, and advanced battery electrodes for use in lead acid batteries. The electrodes may be utilized as a negative electrode and can provide for improved negative-active-material utilization, more uniform current distribution, and enhanced cycle life performance.

Electrodes are provided that can include: a substrate, the substrate comprising non-conductive material; and conductive material associated with the substrate. Electrodes are also provided that include at least two portions, the first of the two portions configured to extend into battery solute and the second of the two portions configured to reside outside the battery solute with the first portion both defining a plurality of recesses and comprising a substrate comprising non-conductive material.

Batteries are provided that can include at least two electrodes, with at least one of the electrodes including: a substrate, the substrate comprising non-conductive material; and conductive material associated with the substrate.

Electricity storage methods are provided that can include: providing electrical current to a battery, the battery including a plurality of electrodes within a battery solute with at least one electrode in the battery being both inert to the battery solute and including non-conductive material; and storing electricity within the battery.

Electrode production methods are provided that can include: providing a substrate including non-conductive material; and depositing conductive material on the substrate to form an electrode.

### DRAWINGS

Embodiments of the disclosure are described below with reference to the following accompanying drawings.

FIG. 1 is an electrode substrate according to an embodiment of the disclosure.

FIG. 2 is an alternative configuration of the electrode substrate according to an embodiment of the disclosure.

FIGS. 3A and 3B depict an electrode substrate at a stage of processing according to an embodiment of the disclosure.

FIGS. 4A and 4B depict an alternative embodiment of the electrode substrate at a stage of processing according to an embodiment of the disclosure.

FIGS. 5A and 5B depict an electrode substrate at a stage of processing according to an embodiment of the disclosure.

FIGS. 6A and 6B depict an alternative embodiment of the electrode substrate at a stage of processing according to an embodiment of the disclosure.

FIGS. 7A and 7B depict an electrode substrate at a stage of processing according to an embodiment of the disclosure.

FIGS. 8A and 8B depict an alternative embodiment of the electrode substrate at a stage of processing according to an embodiment of the disclosure.

FIG. 9 depicts a peel away representation of an electrode substrate according to an embodiment of the disclosure.

FIG. 10 depicts a peel away representation of an alternative embodiment electrode substrate according to an embodiment of the disclosure.

FIG. 11 depicts a configuration of electrode substrates that may be utilized within a battery according to an embodiment of the disclosure.

FIGS. 12A and 12B are views of a configuration of an electrode substrate according to an embodiment of the disclosure.

FIG. 13 depicts a configuration of an electrode substrate according to an embodiment of the disclosure.

FIG. 14 depicts a configuration of a plurality of electrode substrates according to an embodiment of the disclosure.

FIG. 15 depicts a configuration of a plurality of electrode substrates according to an embodiment of the disclosure.

FIG. 16 depicts a configuration of a plurality of substrates according to an embodiment of the disclosure.

FIG. 17A depicts a top view of a configuration of a battery assembly having a plurality of substrates according to an embodiment of the disclosure.

FIG. 17B depicts a perspective and cutaway view of the assembly of FIG. 17A according to an embodiment of the disclosure.

FIG. 18 depicts a configuration of electrodes including cap and coupling components according to an embodiment of the disclosure.

FIG. 19 depicts a battery assembly according to an embodiment of the disclosure.

FIG. 20 depicts variations of coupling components according to embodiments of the disclosure.

FIG. 21 depicts a battery assembly according to an embodiment of the disclosure.

FIG. 22 depicts a battery assembly according to an embodiment of the disclosure.

FIGS. 23A and 23B are depictions of electrode substrates according to embodiments of the disclosure.

FIG. 24 depicts a battery assembly according to an embodiment of the disclosure.

FIG. 25 is data that may be acquired utilizing assemblies according to embodiments of the disclosure.

FIG. 26 is data that may be acquired utilizing assemblies according to embodiments of the disclosure.

### DESCRIPTION

This disclosure is submitted in furtherance of the constitutional purposes of the U.S. Patent Laws “to promote the progress of science and useful arts” (Article 1, Section 8).

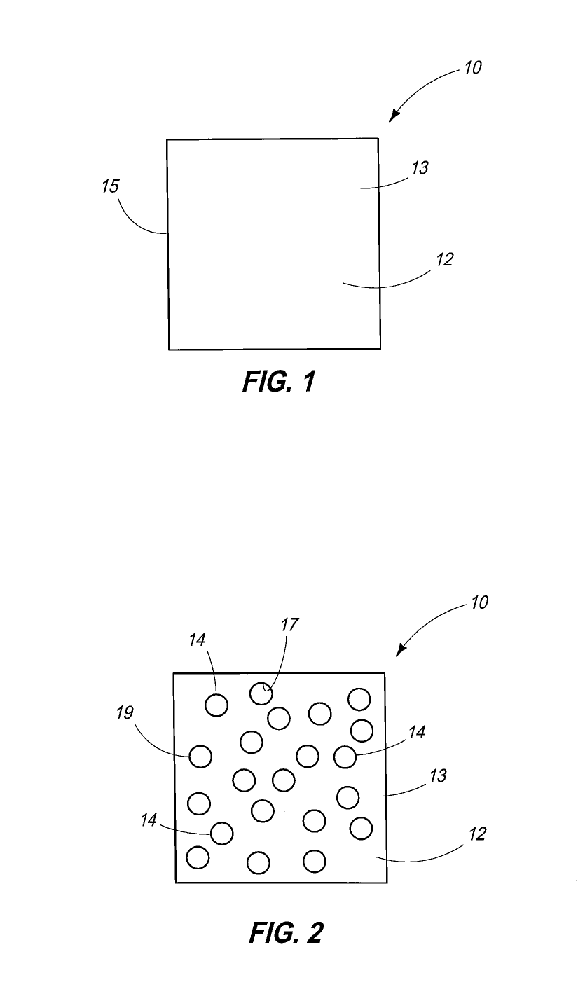

The electrodes, batteries, electrode production methods, battery production methods, rechargeable batteries, lead acid batteries, battery components, and battery methods of the disclosure will be described with reference to FIGS. 1-26. Referring first to FIG. 1, a component of a battery 10 is depicted as electrode substrate 12. This substrate can be a non-conductive, and/or non-metallic, three-dimensional structure that may be stamp molded, injection molded, and/or otherwise fashioned to a final geometric shape as desired. Substrate 12 can vary in shape as desirable and may be dependent upon the final battery design. The substrate can be substantially planar having planar side 13 and edge 15, for example.

The substrates can include structurally supporting material and/or support features such as pasting bars, which may be configured as flanges extending from portions of the substrate that configure the substrate to receive lead paste at a later processing step in the electrode production process. The extension and/or number of the flanges extending from the substrate can vary to the extent desirable to accommodate lead-paste application at later stages of processing. Additionally, substrate 12 can include etched or deposited lines of material between layers that may act as support features, for example.

Substrate 12 can be described to have at least two portions with the one of the two portions being configured to extend into battery solute and the second of the two portions being configured to reside outside the battery solute such as one or more tabs that may be configured to couple to a connecting post for example. The tab location, size and/or shape may change commensurate with battery design as desired. The substrate or portions thereof, particularly the portion within the battery solute may be an inert wherein it may be inert to conditions typically present in batteries, such as, for example, current flows, heat, dissipation of heat, and/or acidic conditions relating to the battery solute, for example.

The substrate may be comprised of one or more of fiberglass, nylon, polyimide, polyamide, polypropylene, polyethylene, cellulose, or acetylene butyl styrene (ABS). In accordance with particular implementations, the substrate may be an “FR-4.” FR-4 is a term commonly used in the computer-hardware-components trade and is a NEMA grade designation for glass-reinforced-epoxy-laminate sheets. FR-4 is frequently used in the manufacture of hardware components, and has been recognized as a versatile-high-pressure-thermoset-plastic-laminate grade having useful strength to weight ratios in certain implementations. Typically, FR-4 has limited water absorption and is used as an electrical insulator possessing substantial mechanical strength.

Other trade name laminates may be utilized as substrate 12 as well. For example, G10/FR-4 is a material fabricated from glass woven cloth impregnated with an epoxy resin binder. The epoxy resin can yield a laminate with useful mechanical properties that may exhibit useful dielectric properties under dry and wet conditions. G11/FR-5 is another laminate similar to the above laminate, with a higher working temperature and useful mechanical strength at elevated temperatures. The material is fabricated from a glass woven cloth impregnated with an epoxy resin binder. The epoxy resin can yield a laminate with useful mechanical properties and this material can exhibit useful dielectric properties under dry and wet conditions. GPO1 is a material fabricated from a glass woven cloth impregnated with a polyester resin. This general purpose grade has useful thermal electrical and mechanical properties. GPO3 is a material fabricated from a glass woven cloth impregnated with a polyester resin. This material is recognized by United Laboratories as having a 180 second arc-resistance and flammability class 94VO. CEM-3, CEM-4, and/or CEM-5 may be used as well.

Referring next to FIG. 2, substrate 12 of electrode 10 may include recesses such as openings 14. Openings 14 may be spaced randomly throughout substrate 12 and may be utilized as a support feature to facilitate the binding of materials such as lead paste material to substrate 12 at a later stage of electrode preparation processing. Openings 14 can have sidewalls 17 extending between planar surfaces 13 of electrode 12, for example. At least a portion of the sidewalls 17 and surfaces 13 can be considered edges of the openings 19 and these edges may be angled and/or beveled, for example.

In accordance with example implementations, substrate 12 may have openings therein, or it may not have openings therein. Where openings are present, the electrode may include additional materials in the form of layers and/or lines deposited and/or etched thereon. These materials may extend via the openings between opposing surfaces of the substrate. For example, materials, such as conductive, lead oxide, and/or lead paste materials may be associated with planar surfaces (sides) 13 as well as sidewalls 17 and/or edges 19. In accordance with example implementations, one or more of these materials may extend through openings 14 closing opening 14. For example, lead paste material can extend through opening 14 effectively closing opening 14. In accordance with other embodiments, lead paste material may extend through opening 14 leaving access through opening 14, for example.

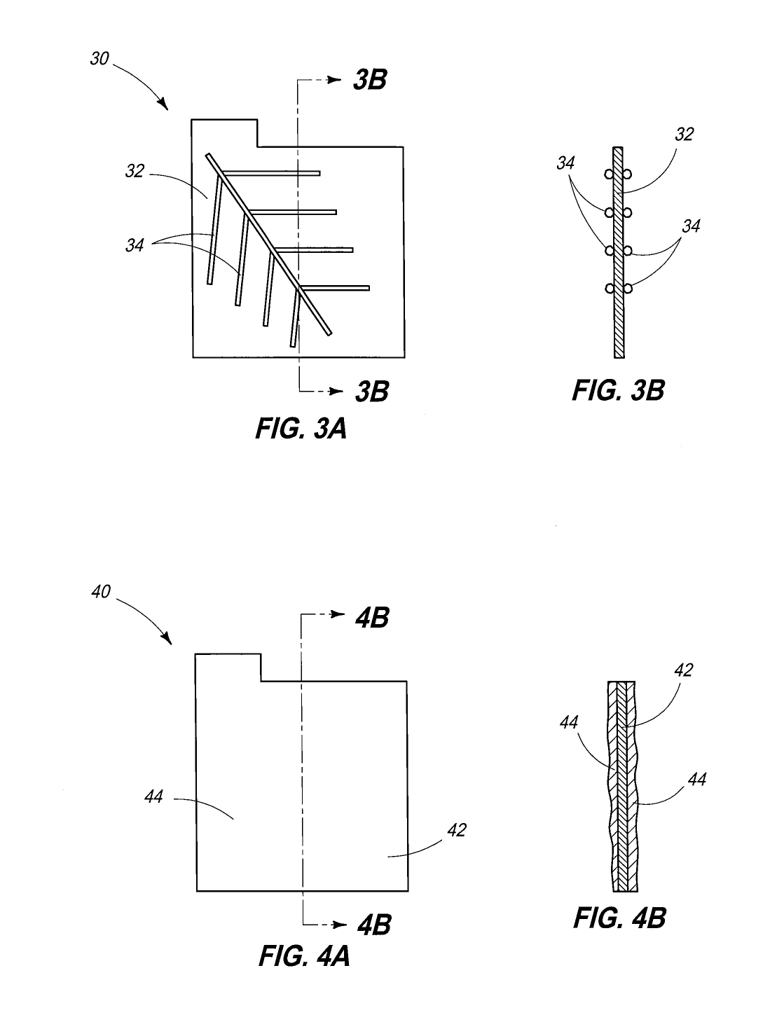

Referring next to FIGS. 3A and 3B, an embodiment of an electrode 30 is shown at a stage of processing. While the stages of preparation or manufacture of the electrodes are shown with representation to one side, cross-sections are also shown with representation to both sides. One more material may be associated with the substrate and/or other materials previously associated with the substrate and/or other materials. This association can be a coupling, and/or a plating. The materials may reside on and/or may be bonded to the other materials or substrates in accordance with this association. It is contemplated that the substrate may support one or more of the materials. This support may be internal or external. For example, the substrate may be internal to the electrode 30 or it may be external to materials, such as conductive materials of electrode 30. As an example, conductive material may be provided with lead material thereover and inserted into a mold, such as a plastic injection mold configured to mold the substrate over the materials leaving exposed portions of the conductive material for the later application of lead past material at a later stage of processing.

In accordance with this stage of processing for example, a conductive material 34 is provided to substrate 32. Substrate 32 can be consistent with the substrates previously described, and may include recesses such as openings as previously described. In accordance with example implementations, at least a portion of conductive material 34 is provided on substrate 32 in the form of lines. These lines can be formed as desired via processing techniques available to those skilled in the art, such as the electric deposition and/or etching of material 34 as lines on substrate 32. In accordance with example implementations, at least a portion of the lines deposited or etched on substrate 32 extend to an area or portion that is to be utilized for later connection with a battery post such as a tab 31. Referring to FIG. 3B, as is shown, lines 34 are typically raised above substrate 32 and may be deposited on opposing surfaces of substrate 32. In accordance with example implementations, these lines can act as structural support material.

Referring next to FIGS. 4A and 4B, according to an alternative implementation, an electrode 40 is shown having conductive material 44 extending over substrate 42. As shown in FIG. 4A, conductive material 44 extends as a layer across substrate 42. Conductive material 44 as shown is not in the form of lines but can be considered a conforming layer of material extending across substrate 42. Referring to FIG. 4B, this material is shown as a roughened material; however, conductive material 44 may have a flat or planar surface as well.

Both conductive materials 34 and 44 can be associated with the substrate. The conductive material may be any conductive material other than lead. For example, the conductive material may include copper, aluminum, silver, gold, nickel, and/or alloys of same. Conductive materials may be etched and/or glued to the respective substrates. While represented as round, materials 34 and 44 may take other shapes, including shapes with edges. The thickness of materials 34 and 44 is commensurate with design requirements. Typically copper applications can be about 35 microns thick.

In accordance with example implementations, the substrate may be purchased having a conductive material already laminated thereto in the form of clad material, such as copper clad substrates. For example, FR-4 copper clad (also known as FR-4 PCB) is a fire-rated-electrical-grade-dielectric-fiberglass-laminated-epoxy resin system combined with a glass-fabric-substrate laminated to copper. The copper clad G10/FR-4 material is compliant with IPC 4101/21. Panels may be machined and circuitry defined to various degrees utilizing high speed hole drilling and milling with CNC machines, for example. These copper clad FR-4 grades are available in ½ ounce, 1 ounce, and 2 ounce weights, for example. Heavier weights are available up to 6 ounces. These clad materials are available in single side or double side sheets.

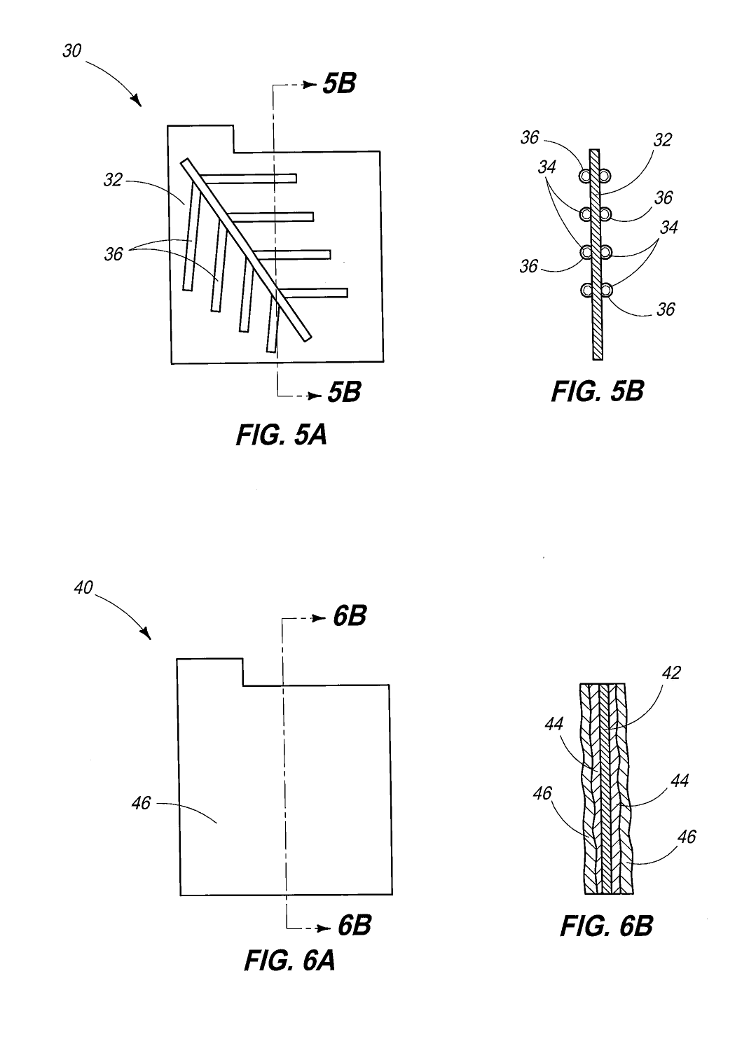

Referring next to FIGS. 5-6, a lead material is shown associated with one or both of the substrate and the conductive material. Referring to FIG. 5A, a lead material 36 is provided over conductive material 34, for example. This lead material is provided to cover and/or encase the lines of conductive material 34 against substrate 32. In accordance with example implementations, the lead material can be provided to compliment the form of the conductive material 34. Referring to FIG. 5B, this lead material can be applied to both sides of substrate 32.

Referring to FIGS. 6A and 6B, lead material 46 is applied to encase conductive material 44, for example. In accordance with example implementations, this lead material 46 may encase all of conductive material 44 and may be applied as a layer over conductive material 44. Referring to FIG. 6B, lead material 46 may be applied to one or both sides of substrate 42, for example. In accordance with example implementations, the lead material may be applied to only one side while leaving the other side free of lead material. The lead material can be one or more of a substantially pure lead material, lead oxide material, and/or lead alloy material. Alloys of the lead material can include tin alloys, for example.

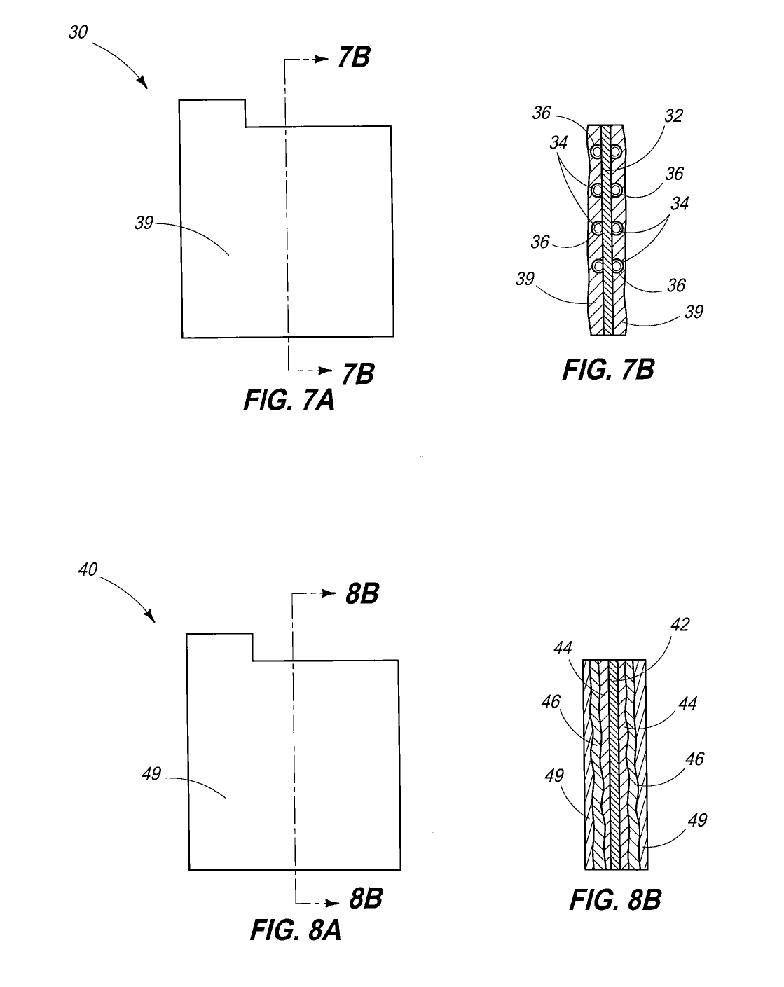

Referring to FIGS. 7-8, lead paste material is shown associated with and/or supported by, one or both of the substrate and the lead material. Referring to FIGS. 7A and 7B, for example, a lead paste 39 may be applied to electrode 30. The lead paste material may cover all or a portion of electrode 30 and it may cover all or a portion of lead material 36 encasing conductive material 34. As shown in FIG. 7B, the lead paste material can be applied to both sides of substrate 32. In accordance with example implementations, this application may be to only one side. Referring to FIG. 2, substrate 32 may have recesses such as openings extending therethrough. These recesses such as openings may now be filled with the lead paste material 39 and/or lead paste material may extend through the openings leaving at least a portion of the openings clear.

Referring to FIGS. 8A and 8B, for example, electrode 40 can include lead paste material 49 extending thereover. In accordance with example implementations, the lead paste material can extend the entirety of electrode 40 and with reference to FIG. 8B, lead paste material 49 may extend over lead material 46 which extends over conductive material 44. As with FIG. 7B above, substrate 42 may include recesses such as openings that are filled with lead paste material 49, and/or lead paste material may extend through the openings leaving at least a portion of the openings clear. The formulation of this lead paste material is known to persons of ordinary skill in the art of lead-acid battery production and is not critical to the present disclosure. The lead paste material may include additives, for example, that can be used to increase surface area. In accordance with example configurations, lead paste material can be considered porous when compared to the lead material described above. The substantially pure lead, lead oxide and/or lead alloys of the lead material can be substantially homogenous thereby preventing battery solutes from contacting the conductive material.

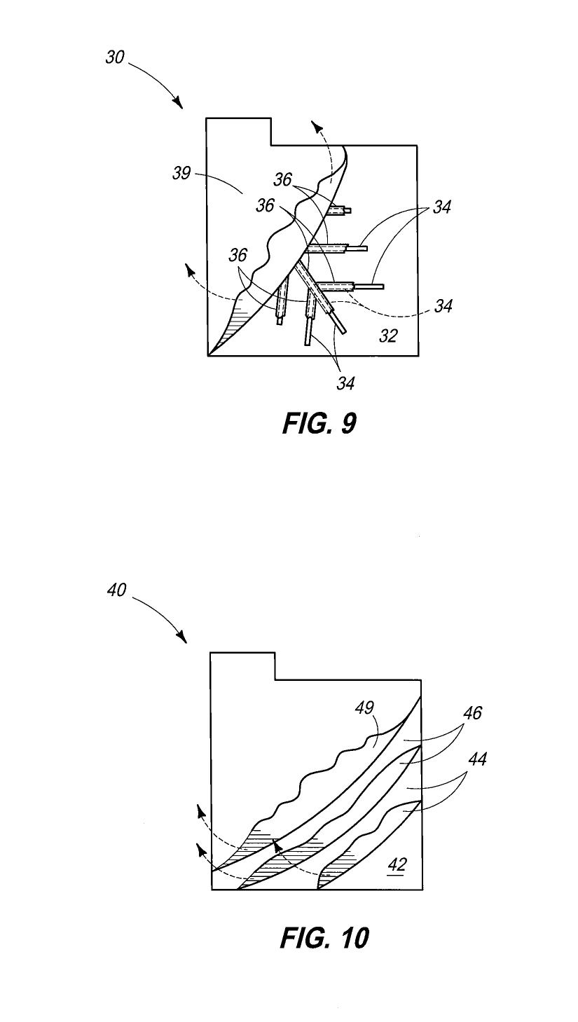

Referring to FIGS. 9 and 10, peel away depictions of embodiments of the electrodes 30 and 40 are shown representing the different layers and/or respective etchings and/or layers. As described above, electrodes can be described in portions, with the one portion for coupling and another for exposure to battery solute. According to example implementations, the materials applied to the substrate may be uniformly applied to both of these portions. According to other implementations, portions of the substrate may have materials applied thereto that are not applied to other portions.

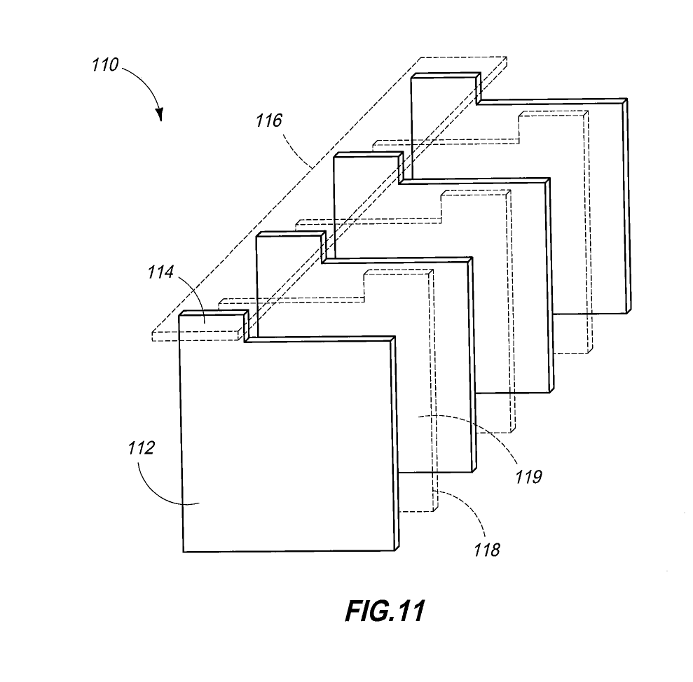

Referring to FIG. 11, an example battery 110 with electrodes 112 is shown. Electrodes 112 can be as described herein. For example, electrode 112 can include a substrate of non-conductive material with conductive material associated with the substrate. Electrodes 112 can have portions with one of the portions being tab 114 and another of the portions defining recesses, for example. In accordance with example implementations, materials deposited or etched onto the electrode are in electrical communication with tabs 114.

Battery 110 can include post component 116 electrically coupled to electrodes 112 of like polarity. Tabs 114 can be in electrical contact with post 116, for example. Electrodes 112 can be configured as the electrodes described herein and may be considered negative electrodes as implemented into a battery configuration. Battery 110 can include opposite electrodes 118 and in between these electrodes can be an electrically torturous barrier known in the battery industry as a separator and/or a battery solute such as fluid 119. Fluid 119 between the electrodes can be a sulfuric acid solution, for example, having a specific gravity of, but not limited to, 1.200 to 1.340, for example. According to example implementations, these batteries can be configured as lead acid batteries.

Batteries described herein can include flat-plate, tubular, circular, and/or bi-polar batteries. The battery can be at least one of a plurality of batteries within a bank of batteries, for example. As another example, the battery can be configured as a bank of individual batteries. In accordance with example implementations, storing electricity within these batteries can include providing electrical current to the battery. The battery can have an electrode that is both inert to the battery solute and include non-conductive material. The electrical current can be provided to one or more post components in electrical communication with one or more of the plurality of electrodes of like polarity.

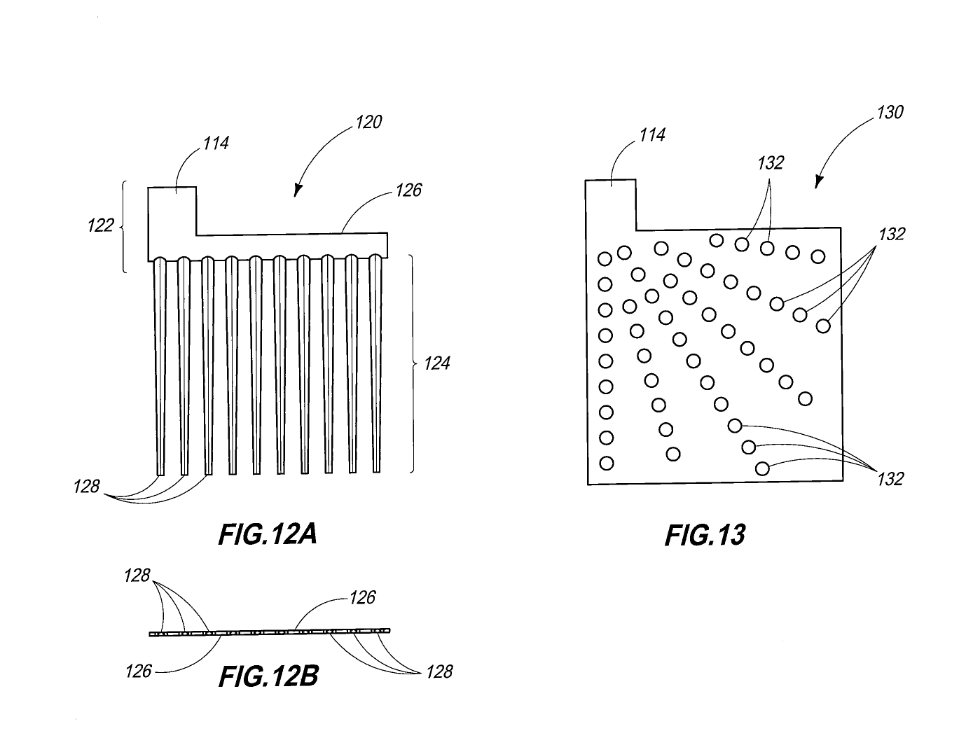

Referring to FIGS. 12-16, various configurations of embodiments of the electrodes are shown. The substrates of the electrodes can be manufactured of the materials described above, for example the inert materials, such as the FR-4 materials. The substrates can be further processed to include the conductive material, lead material, and/or lead paste material as described above as well.

Referring to FIGS. 12-13, substrates of electrodes are shown having recesses such as tines or openings. Referring to FIGS. 12A and 12B, electrode substrate 120 includes a top portion 122 coupled to a lower portion 124. Top portion 122 can include tab 114 having supporting member 126 extending therefrom. Extending downwardly and completing the lower portion 124 of electrode substrate 120 can be a plurality of individual tines 128. These tines can be encapsulated by battery paste, an electrically torturous median, and configured to be exposed to the battery solute such as an electrolyte solution when incorporated in a battery assembly. In accordance with the description of the electrode substrates described herein, the tines can be coated with one or more of the conductive material, the lead material, and/or the lead paste material, for example. Tines 128 can be tapered from a thicker portion proximate supporting member 126 to a thinner portion proximate the terminus of tines 128 as well. Referring to FIG. 12B, an end view of electrode substrate 120 is shown demonstrating tines 128 extending from supporting member 126. In accordance with example implementations, lower portion 124 can be extended into an electrolyte solution as described herein.

Referring next to FIG. 13, an embodiment of the electrode substrate is shown as depicted with electrode substrate 130. Electrode substrate 130 includes a tab 114 but also includes recesses such as openings or orifices 132 extending entirely through substrate 130. Orifices 132 can be consistent with those described in FIG. 2 above, but more particularly orifices 132 are to remain after electrode 130 is completed to include one or more of the conductive material, the lead material, and/or the lead paste material. As shown in previous examples, substrate 130 can be coated with materials as described herein, particularly, the battery related materials. These openings will remain open providing more surface area exposure to electrolyte solution and the conductive materials of the electrode substrate. These orifices are arranged in a certain pattern in FIG. 13; however, other patterns may exist and may be useful as design requirements dictate. Orifices 132 are shown in a circular configuration; however other configurations including rectangular configurations may be utilized. In accordance with example implementations, substrate 130 may be utilized herein in the same manner or fashion as described with reference to the previously described substrates.

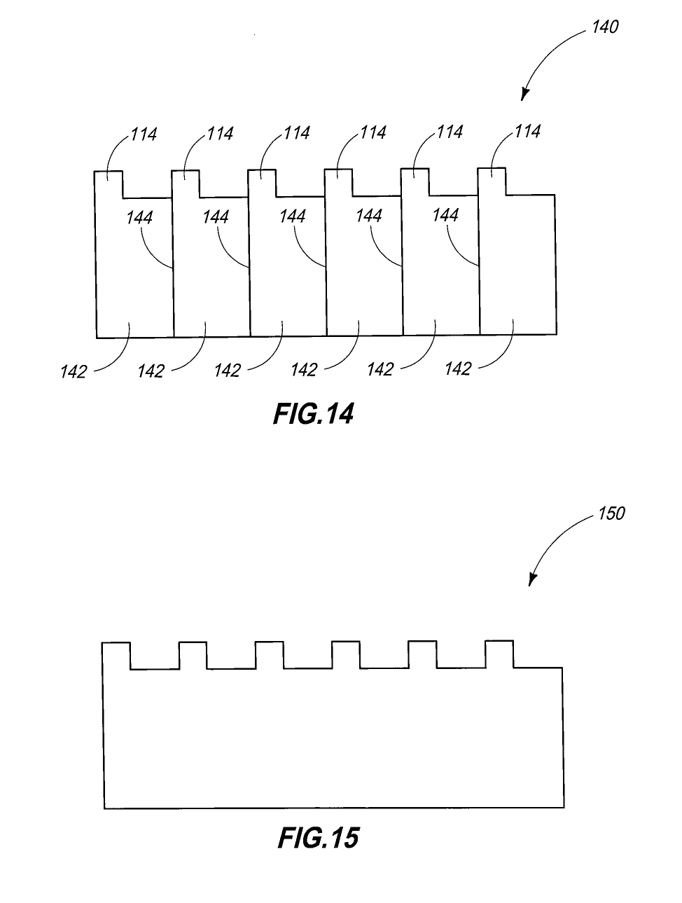

Electrode production methods are provided that can include providing a substrate of non-conductive material and one or more of the conductive material, the lead material, and/or the lead paste as described. In accordance with example implementations, the substrate can be provided clad with conductive material. This substrate can be provided in rolls or sheets. Referring to FIGS. 14 and 15, a plurality of connected electrode substrates 140 and 150 are shown. Substrates 140 and 150 can be manufactured in this fashion to provide sheets or rolls of individual electrode substrates. Upon processing of the rolls or sheets to create recesses such as opening or tines, and/or include one or more the conductive materials, the lead material, and/or the lead paste material, methods can also include separating discrete portions of the sheet or roll from the remainder to form electrodes. In accordance with other implementations, discrete portions may be separated before or after tabs and/or recesses are formed and/or materials are applied.

Referring to FIG. 14, substrates 140 can include individually connected substrates 142. Each of the substrates 142 can include a tab 114. These substrates can be connected via an articulating portion 144, for example. These sheets or rolls of substrates 142 can be configured to join one another at portion 144. Portion 144 can be considered a thinner polymeric portion connecting individual substrates 142. It can also be considered to be a simple taped portion that is not necessarily the same material as the material in substrates 142, for example.

Referring to FIG. 15, substrate 150 can be prepared in sheets or rolls without a hinged portion as described in FIG. 14. In accordance with example embodiments, substrates 150 can be of sufficient flexibility to allow for the production of rolls wherein the material maintains a sufficient flexibility to allow for the curvature of the material into such rolls. In accordance with example implementations, these rolls may be utilized to either prepare individual substrates themselves or they may be used as prepared in battery assemblies.

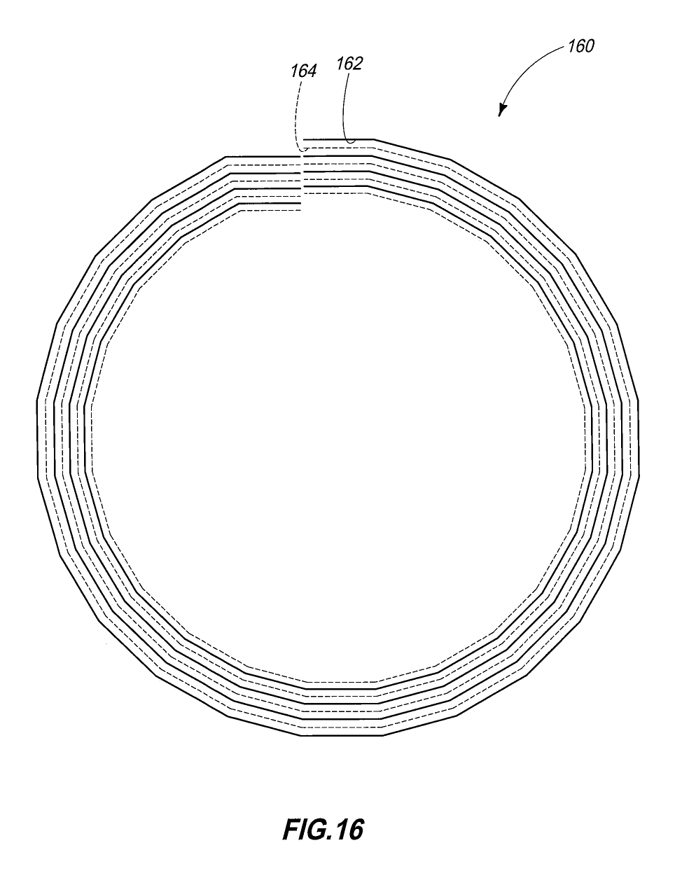

Referring next to FIG. 16, an example configuration of the substrate pluralities 140 and/or 150 is shown. In accordance with example implementations, sheets or rolls of electrodes can be provided in a circular assembly 160. This circular assembly can include electrode substrates 162 aligned in a circular fashion and these electrode substrates 162 can be prepared as a negative or positive conductive electrode. Assembly 160 can further include electrode substrates 164 that can be inset or associated with electrode substrates 162. Substrates 164 can include a negative or positive polarity construction, and this polarity can be the opposite polarity of the electrode it is associated with. As an example, where electrode 162 is a positive electrode, electrode 164 can be configured as a negative electrode. Series of these electrodes can be aligned as shown in FIG. 16 to support a circular serial battery including multiple electrodes. In accordance with example configurations, these electrodes can be serially aligned as shown extending from an outer electrode such as 162 to an inner electrode such as 164. These electrodes can be exposed to an electrolyte solution in a circular container, for example, and also capped to utilize tabs that are associated with the electrodes.

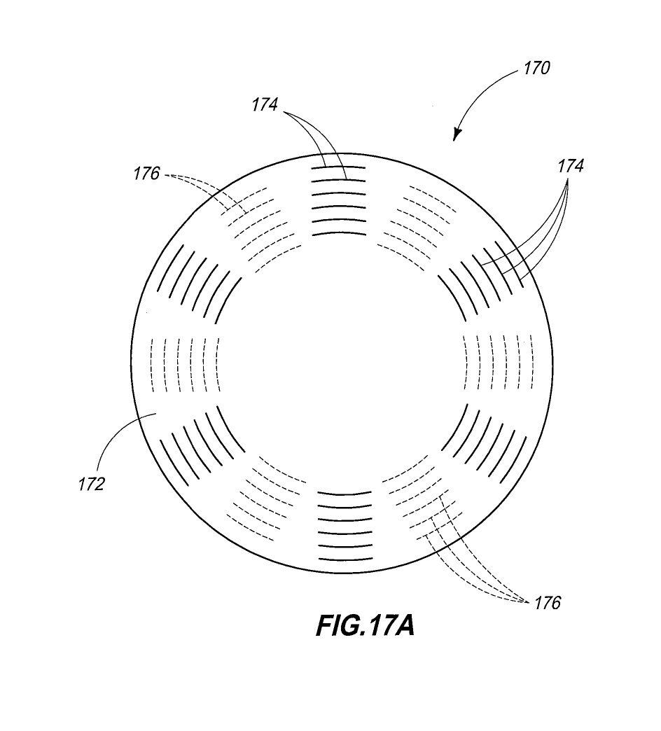

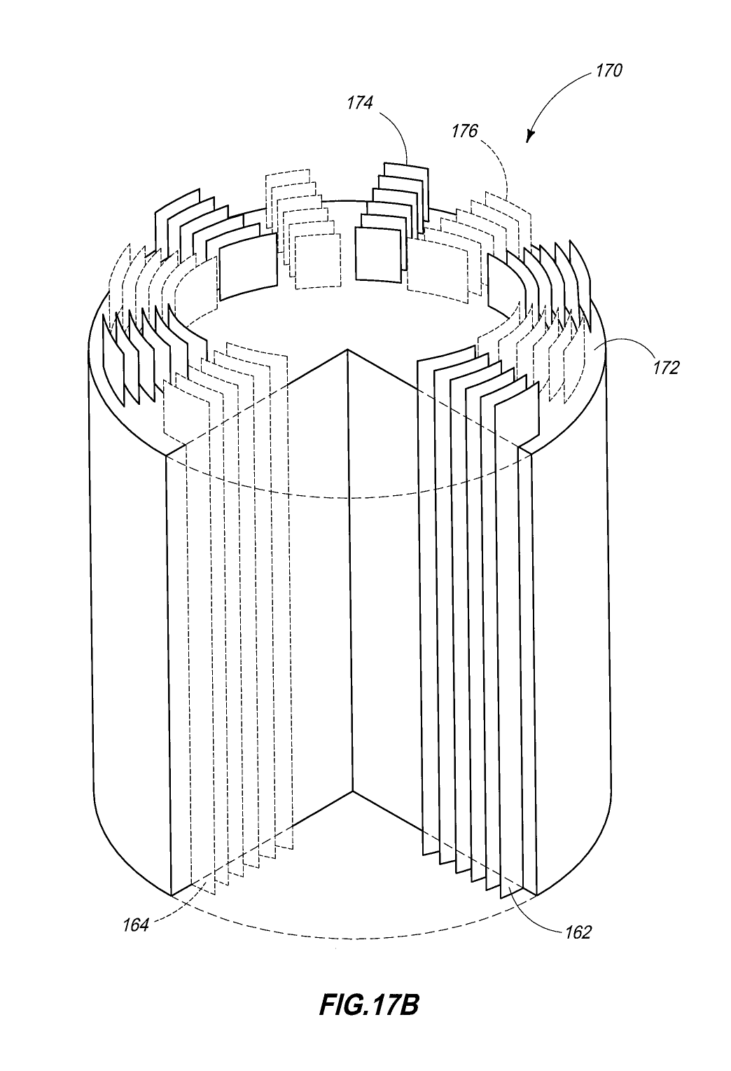

Referring to FIGS. 17A and 17B, depictions of a batter assembly utilizing these circular electrodes are shown. Referring to FIG. 17A, an example top view of battery assembly 170 is shown that includes electrodes of the circular fashion. As can be seen, battery assembly 170 includes a cap or lid assembly 172. Associated with lid assembly 172 can be openings configured to receive tabs 174 and/or 176 associated with electrode substrates therein. As an example, tabs 174 can be associated with, for example, the electrode substrate 162 of FIG. 16, for example. Tabs 176 can be associated with the electrode substrate 164 of FIG. 16, for example. As can be seen, there can be a plurality of tabs associated with individual electrodes, or there may be just single tabs associated with one electrode as desired. Lid assembly 172 can further include conductive materials that allow for the alignment as well as connection of electrodes within assembly 172 via tabs 176 and/or 174, for example. In accordance with example implementations, different tabs can be taken off line or included in line as desired, utilizing cap 172, for example.

Referring to FIG. 17B, an isometric cutaway version of assembly 170 is shown to further depict the configuration of example electrode substrates 164 and 162 within assembly 170. As can be seen, lid assembly 172 resides above electrodes 162 and 164 to form a portion of assembly 170. Assembly 170 can be configured to contain an electrolyte solution, thereby facilitating the battery capabilities of electrode substrates 162 and 164. Tabs 176 and 174 are shown in their raised portions and as can be seen, cap 172 engages these tabs. In accordance with example implementations, this is a battery cell configuration that may be utilized using electrode substrates that are produced in rolls or strips. For purposes of example only, assembly 170 is shown with the number of tabs extending from electrode substrates; fewer or more tabs may be utilized as desired.

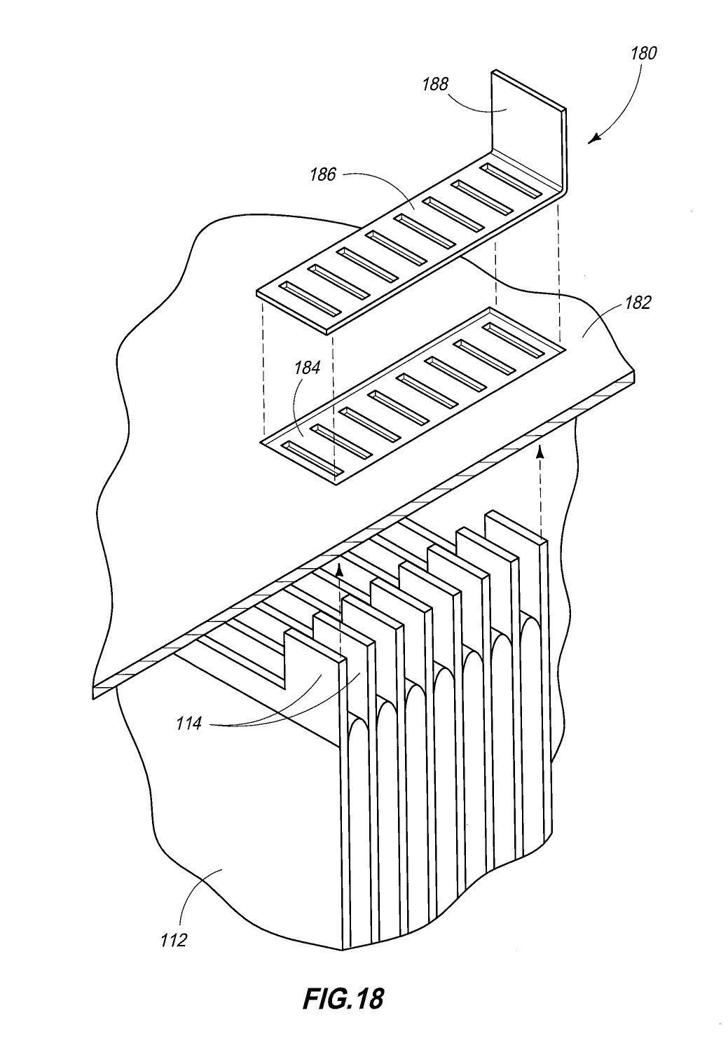

Referring next to FIG. 18, an example battery assembly 180 is shown that includes a plurality of electrode substrates 112 having tabs 114. Assembly 180 can further include a lid assembly 182 that includes a coupling portion 184. Coupling portion 184 can be at least partially conductive and releasably sealable to tabs 114, for example. In accordance with example implementations, assembly 180 can further include a post component 186 that extends to complimentarily receive tabs 114 through assembly 182 and coupling portion 184. Post component 186 can further include an extended post 188 that may be coupled to facilitate alignment of battery cells in accordance with example implementations. Component 186 as well as portion 184 can be manufactured of conductive material.

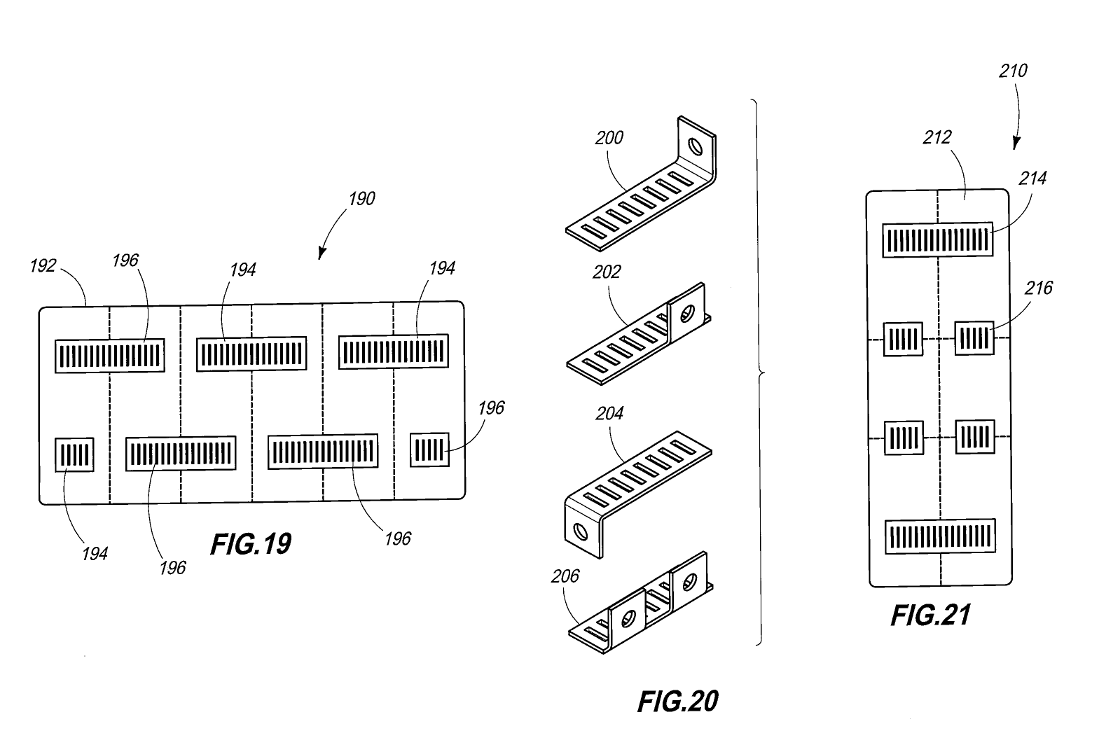

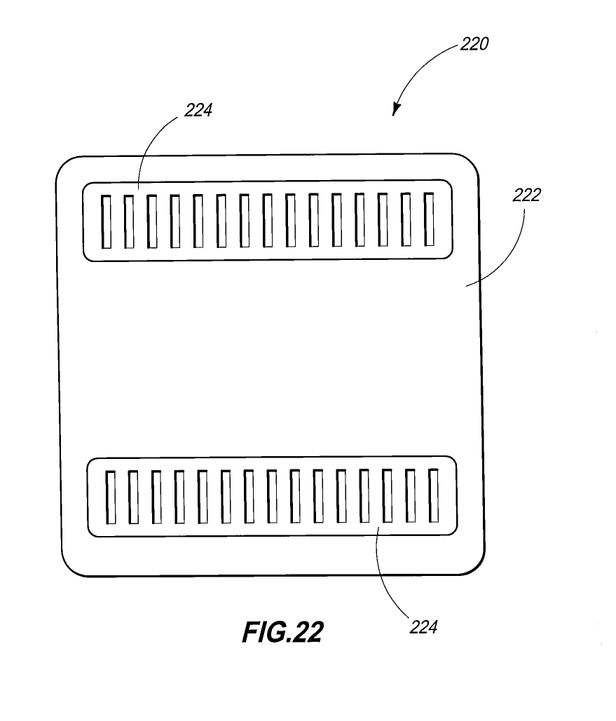

Referring to FIG. 19, a top view of example battery assembly 190 is shown that includes lid assembly 192 that includes coupling portions 194 and 196 for example. These coupling portions may be of different sizes as dictated by the configuration of battery assembly 190. In accordance with example configurations, a 1×6 arrangement of battery cells is shown dictating the size and arrangement of coupling portions 194 and 196. Referring next to FIG. 20, example post components are shown given in example configurations 200, 202, 204, and 206. In accordance with example configurations, the post component configurations demonstrate different post arrangements that may be utilized. Referring to FIG. 21, an example battery assembly 210 is shown in a 2×3 configuration that includes lid assembly 212 having coupling portions 214 and 216 associated therewith. Referring to FIG. 22, a battery assembly 220 is shown in a 2-volt COS arrangement. This 2-volt COS arrangement includes lid assembly 222 associated with coupling portions 224. In accordance with example configurations, these battery configurations may be utilized in serial and/or parallel configurations.

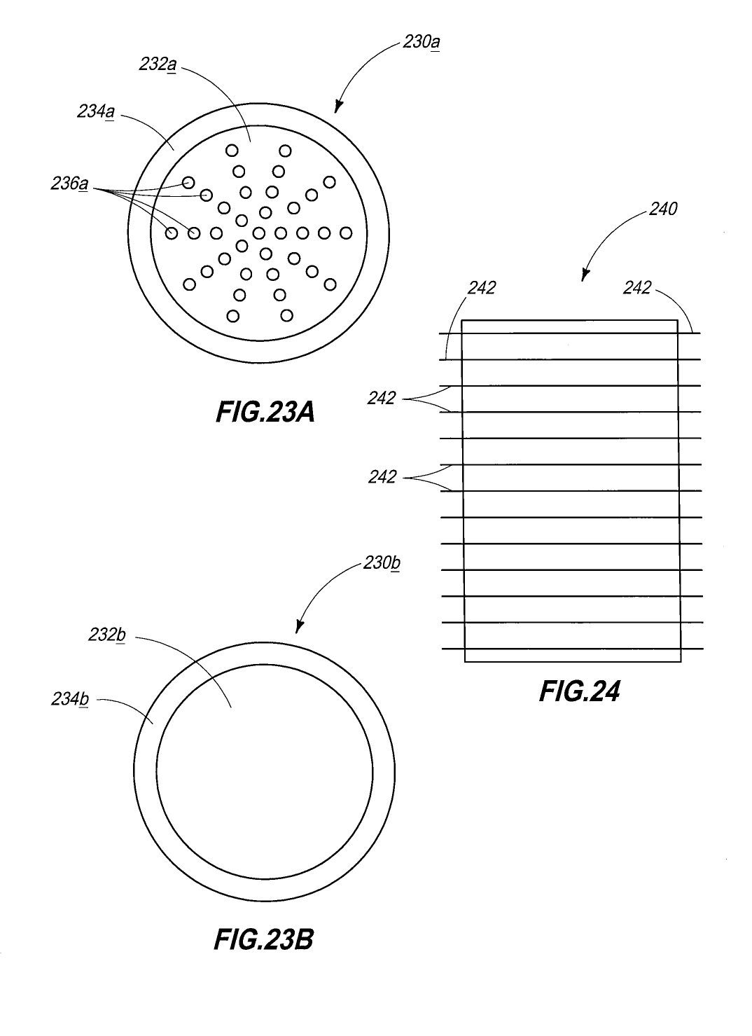

Referring next to FIGS. 23A and 23B, alternate embodiments of electrode substrates are shown. With reference to FIG. 23A, electrode substrate 230a can include a portion 232a that is clad or composited as described previously with reference to electrode substrates and portion 234a that can function as tab 114 as previously described with reference to electrode substrates. Portion 232a can be configured to be exposed to electrolyte solution and can include conductive material, lead material, and/or lead paste material as described, and portion 234a can be configured to couple to other electrode substrates for example. Electrode substrate 230a can include openings 236a as described previously and utilized previously. Referring to FIG. 23B, substrate 230b can be configured as described in 230a with the exception that holes or openings 236a are non-existent. Specific to electrode 230b is portion 232b which can be configured to be exposed to an electrolyte solution and include both conductive material, lead material, and/or lead paste material. Portion 234b can be configured to function as a tab 114 previously described. While electrodes 230a and 230b are shown as completely round, this is just an example embodiment. Other embodiments, including embodiments with portions of tabs 232a and/or 232b removed are also contemplated.

Referring to FIG. 24, an example battery assembly 240 is shown that includes a series of the electrodes of the construction described in FIGS. 23A and 23B aligned in a stacked configuration. These electrode substrates 242 can have tab portions extending outside of the cell 240 and allow for the coupling of these electrode substrates as desired.

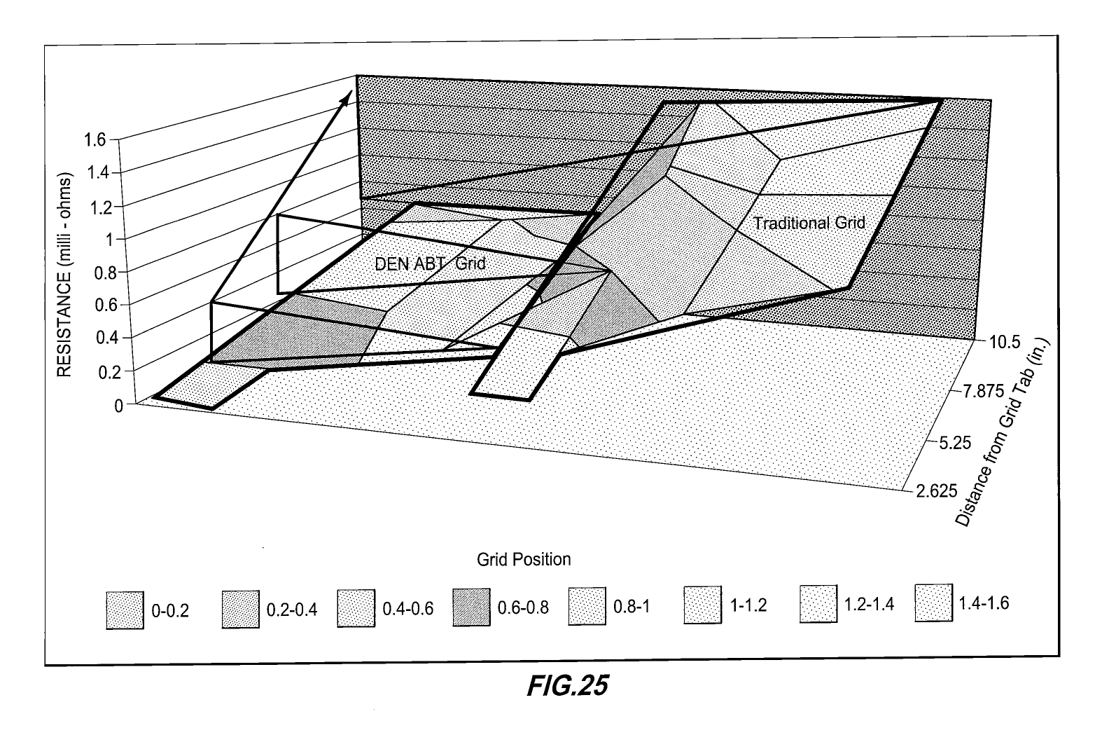

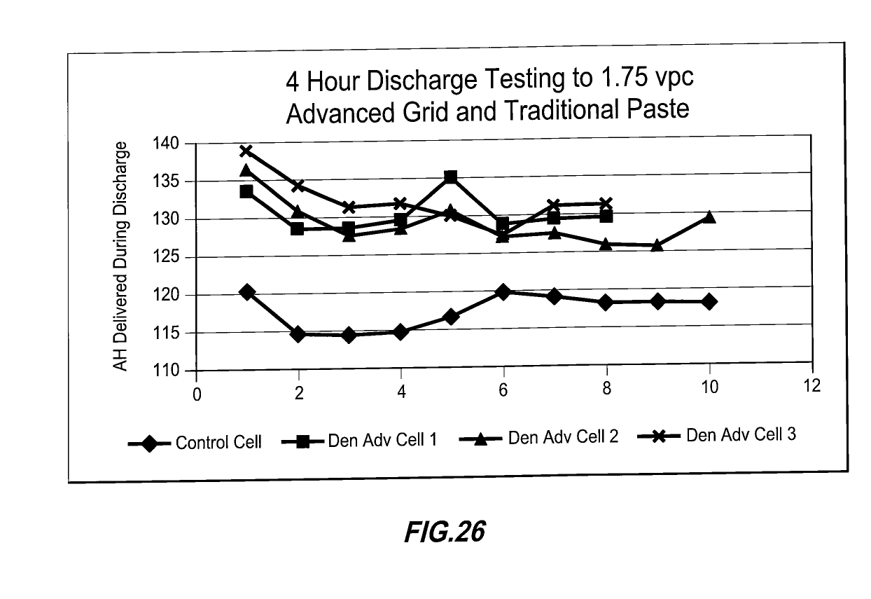

Referring next to FIGS. 25 and 26, data representing third party resistance mapping comparing new advanced negative substrate to traditional lead acid battery negative electrode is shown. As shown in the data, new embodiments herein can be as much as 141% less resistive than traditional negative electrodes. Improved conductivity can allow these new embodiments to operate at lower temperatures and utilize much more of the active material in a much more uniform manner. These improvements can translate into far superior cycle life, for example. With regard to FIG. 26, a scatter pause is shown in the initial performance of the gains through the use of these improved negative electrodes.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

1. An electrode comprising:
a substrate, the substrate comprising non-conductive material; and
conductive material associated with the substrate.

2. The electrode of claim 1 wherein the substrate is substantially planar and defines a plurality of openings extending between the planar sides of the electrode.

3. The electrode of claim 2 wherein the openings define sidewalls extending between the planar sides, the conductive material associated with both the planar sides and the sidewalls of the openings.

4. The electrode of claim 2 further comprising lead paste material supported by the substrate and extending through at least one of the openings.

5. The electrode of claim 2 wherein the plurality of openings form a pattern structurally supporting material applied to the electrode.

6. The electrode of claim 2 wherein one or more of the openings define edges between the planar side and sidewall of the openings, these edges are beveled.

7. The electrode of claim 1 wherein the substrate comprises one or more of fiberglass, polyimide, polyamide, polypropylene, polyethylene, cellulose, or acetylene butyl styrene.

8. The electrode of claim 1 wherein the substrate comprises a glass-reinforced-epoxy-laminate.

9. The electrode of claim 1 wherein the conductive material is conductive material other than lead.

10. The electrode of claim 9 wherein the conductive material comprises one or more of copper, aluminum, silver, gold, nickel, and/or alloys of same.

11. The electrode of claim 1 further comprising a lead material associated with the conductive material.

12. The electrode of claim 1 further comprising:
a lead material associated with the conductive material; and
a lead paste material associated with the lead material.

13. The electrode of claim 1 further comprising lead paste material supported by the substrate.

14. An electrode comprising at least two portions, the first of the two portions configured to extend into battery solute and the second of the two portions configured to reside outside the battery solute, the first portion both defining a plurality of recesses and comprising a substrate comprising non-conductive material.

15. The electrode of claim 14 wherein the first portion defines a plurality of tines.

16. The electrode of claim 14 wherein the first portion defines a plurality of openings.

17. The electrode of claim 16 further comprising:
conductive material associated with the substrate;
lead material associated with the conductive material;
lead paste material associated with the lead material; and
wherein passage through one or more of the plurality of openings remains clear.

18. The electrode of claim 14 further comprising conductive material deposited on the substrate of the first portion.

19. The electrode of claim 18 wherein the conductive material is deposited in the form of lines.

20. The electrode of claim 19 further comprising lead material deposited in the form of lines on the conductive material.

21. The electrode of claim 19 further comprising:
lead material deposited in the form of lines on the conductive material; and
lead paste deposited over the lead material.

22. The electrode of claim 18 wherein the conductive material is deposited in the form of a layer.

23. The electrode of claim 22 wherein the substrate is plated with conductive material.

24. The electrode of claim 22 further comprising lead material layered over the conductive material.

25. The electrode of claim 22 further comprising:
lead material layered over the conductive material; and
lead paste layered over the lead material.

26. A battery comprising at least two electrodes, at least one of the electrodes comprising:
a substrate, the substrate comprising non-conductive material; and
conductive material associated with the substrate.

27. The battery of claim 26 wherein the electrodes further comprise at least two portions, a first portion configured for electrical coupling, and a second portion configured to reside in battery solute.

28. The battery of claim 27 wherein the second portion of the electrode defines recesses.

29. The battery of claim 27 wherein the second portion of the electrode further comprises:
a conductive material associated with the substrate;
a lead material associated with the conductive material; and
a lead paste material associated with the lead material.

30. The battery of claim 27 wherein the first portion is configured as a tab extending from the second portion.

31. The battery of claim 30 further comprising at least one post component coupled to tabs of electrodes of like polarity.

32. The battery of claim 30 further comprising a lid configured to receive one or more tabs or one or more of the electrodes.

33. The battery of claim 26 configured as one of a flat-plate, tubular, circular, or bi-polar battery.

34. The battery of claim 26 being at least one of a plurality of batteries within a bank of batteries.

35. The battery of claim 26 configured as a bank of individual batteries.

36. An electricity storage method comprising:
providing electrical current to a battery, the battery comprising a plurality of electrodes within a battery solute with at least one electrode in the battery being both inert to the battery solute and comprising non-conductive material; and
storing electricity within the battery.

37. The electricity storage method of claim 36 wherein the providing electrical current comprises providing electrical current to one or more post components in electrical communication with one or more of the plurality of electrodes of like polarity.

38. An electrode production method comprising:
providing a substrate comprising non-conductive material; and
depositing conductive material on the substrate to form an electrode.

39. The method of claim 38 further comprising creating one or more recesses in the substrate.

40. The method of claim 39 wherein the creating comprises forming openings within the substrate.

41. The method of claim 39 wherein the creating comprises forming tines from the substrate.

42. The method of claim 38 wherein the providing the substrate and depositing conductive material both comprise providing a substrate clad with conductive material, the method further comprising:
depositing lead material over at least a portion of the conductive material; and
depositing lead paste material over the lead material.

43. The method of claim 38 further comprising applying structurally supporting material applied to the electrode by creating support features within the substrate.

44. The method of claim 38 wherein the depositing the conductive material comprises forming lines of conductive material on the substrate.

45. The method of claim 44 wherein forming lines of conductive material comprises etching conductive material deposited on the substrate.

46. The method of claim 38 further comprising:
depositing lead material over at least a portion of the conductive material; and
depositing lead paste material over the lead material.

47. The method of claim 38 wherein the providing the substrate comprises providing a sheet of substrate material and depositing the conductive material on the sheet, the method further comprising separating discrete portions of the sheet from the remainder to form electrodes.

48. The method of claim 38 wherein the providing the substrate comprises providing a roll of substrate material and depositing the conductive material on the unrolled substrate, the method further comprising separating discrete portions of the unrolled substrate from the remainder to form electrodes.
